(19) United States
(12) Patent Application Publication
(10) Pub. No.: US 2026/0084143 A1
(43) Pub. Date: Mar. 26, 2026

(54) METHOD FOR DISPENSING SAMPLE LIQUID AND PIPETTE FOR DISPENSING SAMPLE LIQUID

(71) Applicant: Festo SE & Co. KG, Esslingen (DE)

(72) Inventors: Martin BOCHTERLE, Fellbach (DE); Heiko Patz, Weilheim (DE)

(21) Appl. No.: 19/340,085

(22) Filed: Sep. 25, 2025

(30) Foreign Application Priority Data
Sep. 25, 2024 (DE) 102024127704.1

(51) Int. Cl. B01L 3/02

(52) U.S. Cl. CPC B01L 3/0237; B01L 2200/06; B01L 2200/143; B01L 2300/0663; B01L 2400/0478; B01L 2400/082

(57) ABSTRACT

A method for dispensing a sample liquid including evaluating a pressure signal from the tip pressure sensor with the control device to obtain a working fluid pressure, evaluating a flow signal from the flow sensor arrangement with the control device to obtain a sample liquid flow rate, changing a pressure for working fluid received in the pipette tip holder with the working fluid device according to a first curve for the working fluid pressure, so that sample liquid passes through a dispensing opening of the pipette tip spaced apart from the pipette tip holder, determining a flow resistance characteristic value for the sample liquid, taking into account the working fluid pressure and the sample liquid flow rate, and then changing the pressure for the working fluid received in the pipette tip holder again using the working fluid device according to a second working fluid pressure curve.

### CROSS-REFERENCE TO RELATED APPLICATION

This application claims priority to German application 10202412704.1, filed Sep. 25, 2024, which is incorporated herein by reference.

### BACKGROUND OF THE INVENTION

The invention relates to a method for dispensing sample liquid and a pipette for dispensing sample liquid.

Pipettes known from the prior art for dispensing a sample liquid comprise, for example, a working fluid device, a pipette tip holder, and a pipette tip that can be filled with sample liquid.

The pipette tip is fluidically connected to the pipette tip holder. By means of the working fluid device, a pressure for working fluid received in the pipette tip holder can be changed in order to discharge sample liquid received in the pipette tip from the pipette tip, i.e., to dispense it, or to take it up into the pipette tip, i.e., to aspirate it. In order to discharge or dispense sample liquid from the pipette tip, the pressure for the working fluid received in the pipette tip holder is increased by means of the working fluid device; to take up or introduce sample liquid into the pipette tip, this pressure is reduced, resulting in a corresponding suction effect.

The change in pressure can be achieved in various ways. For example, there are so-called piston pipettes in which the working fluid device comprises a cylinder and a piston held in the cylinder. A piston rod is arranged on the piston, by means of which a movement of the piston in the cylinder can be caused. Such movement leads to a change in the volume of a piston chamber bounded by the piston in the cylinder. This piston chamber contains a working fluid, in particular a gas, which, following the change in volume and thus the movement of the piston, is either expanded, thereby reducing the pressure in order to aspirate sample liquid, or is compressed, thereby increasing the pressure in order to dispense sample liquid.

In addition, there are pipettes in which the working fluid device comprises a positive pressure source which, when required, i.e., when sample liquid is to be dispensed, is connected fluidically to the pipette tip holder so that the pressure for the working fluid contained in the pipette tip holder is increased. In this way, dispensing can be performed with such pipettes, which may be designed as so-called air-lock pipettes or gas flow sensor-controlled pipettes. In order to enable aspiration with such a pipette, a negative pressure source may also be provided, which is then connected fluidically to the pipette tip holder or can be connected to the pipette tip holder when required, respectively, so that the pressure for the working fluid received in the pipette tip holder is reduced. The fluid connection between the pipette tip holder and the positive pressure source or the negative pressure source can be switched by means of valves. For example, a suitably arranged valve can be moved to an open position in order to establish the relevant fluid connection, or moved to a closed position in order to terminate the relevant fluid connection.

Pipettes are known in which the positive pressure source and, if applicable, the negative pressure source are arranged outside the base body of the pipette.

### SUMMARY OF THE INVENTION

The object of the present invention is to provide a method for dispensing a sample liquid and a pipette for dispensing a sample liquid, which feature high accuracy in performing the dispensing operation.

This task is solved by a method for dispensing a sample liquid with a pipette comprising a working fluid device, a flow sensor arrangement, a pipette tip holder, a pipette tip that can be filled with sample liquid, a tip pressure sensor arranged on the pipette tip holder, and a control device, with the following steps: Evaluating a pressure signal from the tip pressure sensor with the control device in order to obtain a working fluid pressure, evaluating a flow signal from the flow sensor arrangement with the control device in order to obtain a sample liquid flow rate, changing a pressure for working fluid received in the pipette tip holder with the working fluid device in accordance with a first curve for the working fluid pressure, in particular as specified by the control device, so that sample liquid passes through a dosing opening of the pipette tip located at a distance from the pipette tip holder, determining a flow resistance characteristic value for the sample liquid, taking into account the working fluid pressure and the sample liquid flow rate, and then again changing the pressure for the working fluid received in the pipette tip holder with the working fluid device in accordance with a second working fluid pressure curve, which is specified in particular by the control device, wherein the second curve for the working fluid pressure is determined taking into account the flow resistance characteristic value so that a predetermined sample liquid quantity passes through the dosing opening.

According to the invention, it is intended that the above method be carried out with a pipette in which the pipette tip can be removed from the pipette tip holder and replaced by another pipette tip, in particular one that has not been used before or has at least been cleaned after use. In addition, according to the invention, it is provided that the sample liquid only comes into contact with the replaceable pipette tip, but not with the pipette tip holder.

For this purpose, the pipette tip is preferably designed so that the amount of sample liquid to be received in the pipette can be completely received in the pipette tip. Common internal volumes of such pipette tips range from 10 microliters to 10,000 microliters and, in particular from 20 microliters to 2,000 microliters. A common internal volume of a corresponding pipette tip holder ranges from 20 microliters to 5,000 microliters, preferably from 50 microliters to 1,000 microliters, and particularly preferably from 150 microliters to 800 microliters.

In this way, it is possible to prevent the pipette tip holder from having to be cleaned extensively after dispensing sample liquid. This is particularly advantageous in the case of sample liquids that have a contaminating effect, for example biological or medical sample liquids such as blood. In particular, the pipette tip is designed as a disposable or single-use item.

The pipette tip may be empty before it is coupled with the pipette tip holder, so that it can then be filled with sample liquid when it is coupled with the pipette tip holder.

When the pipette tip is coupled with the pipette tip holder, there is a fluid connection between the pipette tip holder and the pipette tip. This means that fluid, in particular working fluid, can enter the pipette tip from the pipette tip holder and, conversely, can enter the pipette tip holder from the pipette tip. If working fluid enters the pipette tip, sample liquid received in the pipette tip can be released, i.e., dispensed, from the pipette tip. If working fluid enters the pipette tip holder from the pipette tip, sample liquid can be received, i.e., aspirated, the pipette tip.

The change or progression of pressure of the working fluid received in the pipette tip holder can be an indication of how much sample liquid is aspirated into or dispensed from the pipette tip and how quickly the aspiration or dispensing takes place. The tip pressure sensor is provided to detect the change in pressure for the working fluid received in the pipette tip holder.

The sample liquid flow rate can also be an indication of how much sample liquid is aspirated into or dispensed from the pipette tip and how quickly the aspiration or dispensing takes place. The flow sensor arrangement is provided to detect the sample liquid flow rate. The sample liquid flow rate can be a volume flow of sample liquid or a mass flow of sample liquid. Furthermore, the sample liquid flow rate can be a flow velocity of the sample liquid. In addition, the sample liquid flow rate can be a volume of sample liquid that has been aspirated into or dispensed from the pipette tip in a certain period of time, or a corresponding mass of sample liquid. Accordingly, the flow sensor arrangement is designed to detect a volume flow, a mass flow, a flow velocity, a volume, and/or a mass.

The flow sensor arrangement may comprise a sensor with which the sample liquid flow rate can be measured directly, for example a volume flow sensor or a mass flow sensor. In addition, the flow sensor arrangement may comprise a sensor with which the sample liquid flow rate can be measured indirectly. Such a sensor for indirect measurement is also referred to as a soft sensor.

In order to aspirate sample liquid through the dispensing opening of the pipette tip into the pipette tip or to dispense sample liquid from the pipette tip, the pressure of the working fluid received in the pipette tip holder is changed. This change is made in accordance with the first curve for the working fluid pressure or, when changed again, in accordance with the second curve for the working fluid pressure. The first and second curves for the working fluid pressure are curves of target values for the working fluid pressure, on the basis of which the actual change in the pressure for the working fluid received in the pipette tip holder is made using the working fluid device.

Between the initial change in the pressure for the working fluid received in the pipette tip holder and the again change in pressure, the flow resistance characteristic value for the sample liquid is determined. The working fluid pressure determined during the initial change in pressure for the working fluid received in the pipette tip holder and the corresponding sample liquid flow rate are taken into account. Preferably, the flow resistance characteristic value is determined by means of a model-based observer and taken into account in a model-based controller. In this case, the relationship between the working fluid pressure and the sample liquid flow rate can be determined by changing the flow resistance characteristic value.

The flow resistance characteristic value also depends on intrinsic properties of the sample liquid. For example, the flow resistance characteristic value may depend on the kinematic viscosity of the sample liquid and/or its density. Furthermore, the flow resistance characteristic value may depend on properties related to the pipette, in particular geometric properties related to the internal geometry of the pipette tip, for example the internal cross-section of the pipette tip and/or the profile of such an internal cross-section. Purely by way of example, the flow resistance characteristic value depends on the kinematic viscosity of the sample liquid, the density of the sample liquid, and the geometric properties of the pipette tip. Once the flow resistance characteristic value has been determined and, for example, the geometric properties of the pipette tip and the density of the sample liquid are known, the kinematic viscosity of the sample liquid can be inferred from the flow resistance characteristic value.

The second curve for the working fluid pressure is determined taking into account the flow resistance characteristic value. In this context, it should be understood that the flow resistance characteristic value affects the second curve for the working fluid pressure. Accordingly, the second curve for the working fluid pressure is affected by the working fluid pressure and sample liquid flow rate recorded during the initial change in pressure for the working fluid received in the pipette tip holder. The initial change in pressure for the working fluid received in the pipette tip holder can thus be regarded as a kind of trail shot, in which knowledge about the sample liquid to be dispensed is obtained. This knowledge is then taken into account when the pressure for the working fluid received in the pipette tip holder is changed again in order to dispense a specified amount of sample liquid with high accuracy.

For example, the initial change in pressure for the working fluid received in the pipette tip holder can be performed as aspiration of sample liquid, for example from a sample liquid reservoir, and the subsequent change in pressure for the working fluid received in the pipette tip holder can be performed as dispensing of the previously aspirated sample liquid, for example into a sample vessel. Preferably, the pressure for the working fluid received in the pipette tip holder is changed again several times in succession with the same sample liquid as dispensing. For example, the same sample liquid can be dispensed several times in succession into different sample vessels without having to determine the flow resistance characteristic value again each time.

If different sample liquids were dispensed with the same working fluid pressure curve regardless of their flow resistance characteristic, then low-viscosity sample liquids would be dispensed so quickly that they would splash uncontrollably when they hit a sample vessel. Viscous sample liquids, on the other hand, would be dispensed so slowly that they could not be slowed down or delayed sufficiently at the end of the dispensing process, so that a final drop of the sample liquid would remain stuck to the pipette tip and not be completely dispensed from the pipette tip. In both cases, i.e., for sample liquids with low viscosity and with high viscosity, the amount of sample liquid arriving in the sample vessel would not correspond to the specified sample liquid amount.

By determining the second curve for the working fluid pressure in accordance with the invention, taking into account the flow resistance characteristic value, the aforementioned risks can be reduced.

Preferably, the pressure for the working fluid received in the pipette tip holder is changed again with the working fluid device according to a second curve for the working fluid pressure, so that a specified sample liquid quantity passes through the dosing opening with a specified curve of the sample liquid flow rate. For example, it is envisaged that the predetermined flow rate of the sample liquid is a predetermined flow velocity of the sample liquid. In this case, the flow rate of the sample liquid can be specified in such a way that, at the end of dispensing, the flow rate is slowed down to the required extent and/or the sample liquid does not exit the pipette tip too quickly. In this way, the residual sample liquid remaining in the pipette tip immediately before the end of dispensing can be slowed down so quickly that even the last drop of the sample liquid breaks off reliably at a constant speed.

Preferably, the pressure for the working fluid contained in the pipette tip holder is changed in a controlled manner. For this purpose, the second curve for the working fluid pressure is used as a reference variable and the working fluid pressure obtained by evaluating the pressure signal of the tip pressure sensor with the control device is used as a control variable, which is fed back to the reference variable. The difference between the reference variable and the fed-back control variable is used as a control deviation and fed to the controller, which implements the control law. In particular, the controller is designed as software. The control can compensate for the influence of disturbance variables on the working fluid pressure. Alternatively, the pressure for the working fluid received in the pipette tip holder is changed again in a controlled manner. The initial change in pressure for the working fluid received in the pipette tip holder is also preferably regulated and alternatively controlled.

Preferably, the flow sensor arrangement is designed as a soft sensor arrangement and determines the flow signal on the basis of at least one pressure signal from a pressure sensor assigned to the working fluid device. In the flow sensor arrangement designed as a soft sensor arrangement, the flow signal is not measured directly with the flow sensor arrangement, but rather a signal of another physical quantity—in this case a pressure signal—is detected, on the basis of which the flow signal is calculated. The flow signal is used like a directly detected measurement signal, even though it is an indirectly detected, only calculated signal. By designing the flow sensor arrangement as a soft sensor arrangement, inexpensive and, if necessary, easily implementable sensors, such as a pressure sensor in this case, can be used instead of expensive or only complex to implement direct measuring sensors, such as a volume flow sensor.

Preferably, the working fluid device has a positive pressure source and/or a negative pressure source, wherein a positive pressure sensor associated with the positive pressure source and/or a negative pressure sensor associated with the negative pressure source are provided, wherein the flow sensor arrangement determines the flow signal on the basis of a pressure signal from the positive pressure sensor and/or a pressure signal from the negative pressure sensor and the pressure signal from the tip pressure sensor. A pipette designed in this way is also referred to as an air-lock pipette. In order to dispense, a fluid connection is established between the relevant pressure source and the pipette tip holder by means of a valve. This creates a pressure equalization between the pressure source and the pipette tip holder.

If the pipette tip holder is fluidically connected to the positive pressure source, positive pressure is created in the pipette tip holder so that sample liquid received in the pipette tip can be dispensed. If the pipette tip holder is fluidically connected to the negative pressure source, a negative pressure is created in the pipette tip holder so that the sample liquid received in the pipette tip can be aspirated. Pressure equalization is achieved by moving the valve to an open position.

Furthermore, it is preferably provided that the valve is designed as a proportional valve, so that a different degree of opening of the proportional valve is set depending on the strength or speed of the required pressure equalization. For example, if strong or fast pressure equalization is required, the valve is opened further than if weak or slow pressure equalization is required.

It is particularly preferred that the working fluid device has a positive pressure source and a negative pressure source, with a positive pressure sensor associated with the source of positive pressure and/or a negative pressure sensor associated with the negative pressure source, whereby the flow sensor arrangement determines the flow signal on the basis of a pressure signal from the positive pressure sensor and a pressure signal from the negative pressure sensor. A pipette designed in this way is also referred to as a dual air lock pipette or gas flow sensor-controlled pipette. With such a pipette, sample liquid can be easily dispensed and aspirated.

Alternatively or in addition, the working fluid device has a piston and the pipette tip holder is designed as a cylinder in which the piston is guided, whereby the flow sensor arrangement is designed as a soft sensor arrangement and the flow signal is determined on the basis of a displacement signal from a displacement sensor assigned to the piston and the pressure signal from the tip pressure sensor. Such a displacement sensor is also referred to as a position sensor. Purely by way of example, the flow signal is determined on the basis of the displacement signal from the displacement sensor associated with the piston and the pressure signal from the tip pressure sensor. A pipette designed in the manner described above is referred to as a piston pipette. The above description of the positive pressure sensor and the negative pressure sensor in relation to the soft sensor arrangement applies equally to the displacement sensor.

The displacement sensor is designed to detect the position of the piston in the cylinder. When the piston is moved in the cylinder, the volume of a piston chamber limited by the piston in the cylinder changes. This piston chamber contains working fluid, which either expands as a result of the change in volume, thereby reducing the pressure, or is compressed, thereby increasing the pressure. In this respect, the position of the piston in the cylinder, i.e., the displacement signal from the displacement sensor, can be used to infer a volume or a change in volume in the piston chamber.

Preferably, when determining the flow resistance characteristic value, a simulated control is performed in which the working fluid pressure is used as the input and the sample liquid flow rate is used as the reference variable, and a simulated sample liquid flow rate is determined by means of a simulation, whereby the simulated sample liquid flow rate is used as a control variable of the simulated control. Such a determination of the flow resistance characteristic value can be referred to as model-based observation. Purely by way of example, the simulated sample liquid flow rate is compared with the sample liquid flow rate, and the control error resulting from the comparison is used in the simulated control to adjust the flow resistance characteristic value in such a way that the sample liquid flow rate used as the reference variable and the simulated sample liquid flow rate used as the control variable become identical.

Alternatively, in the simulated control performed to determine the flow resistance characteristic value, the sample liquid flow rate can be used as the input and the working fluid pressure as the reference variable. The above statements regarding the input and the reference variable apply equally to the alternative reverse use of the sample liquid flow rate as the input and the working fluid pressure as the reference variable.

Preferably, the simulated control simulates a relationship between the working fluid pressure and the sample liquid flow rate, wherein the relationship between the working fluid pressure and the sample liquid flow rate is reflected in the flow resistance characteristic value.

Preferably, the sample liquid flow rate is used as a reference variable of the simulated control, whereby the simulated sample liquid flow rate is used as a measured variable of the simulated control, which is fed back to the sample liquid flow rate used as a reference variable of the simulated control.

Preferably, a control deviation of the simulated control is determined as a difference between the sample liquid flow rate used as a reference variable of the simulated control and the simulated sample liquid flow rate used as a measured variable of the simulated control, wherein the control deviation of the simulated control is fed to a disturbance model of the simulated control, wherein the disturbance model of the simulated control is designed as a function with which a preliminary flow resistance characteristic value is determined, wherein the preliminary flow resistance characteristic value is used as a parameter of the simulated control, wherein preferably the working fluid pressure of the simulation is fed as an input variable.

Furthermore, the control deviation is preferably fed to a controller of the simulated control before being fed to the disturbance model and amplified according to a gain function. This allows the dynamics of the control to be increased.

A pipette according to the invention for dispensing a sample liquid has a working fluid device, a flow sensor arrangement, a pipette tip holder, a pipette tip that can be filled with sample liquid, a tip pressure sensor arranged on the pipette tip holder, and a control device, wherein the control device is designed to carry out a method described above.

### BRIEF DESCRIPTION OF THE DRAWINGS

The invention is explained in more detail below with reference to the accompanying drawings, in which:

FIG. 1 shows a pipette for dispensing a sample liquid with a positive pressure source and negative pressure source,

FIG. 2 shows another pipette for dispensing a sample liquid with a piston and a pipette tip holder designed as a cylinder,

FIG. 3 shows a detail of a pipette with a small amount of sample liquid received in the pipette tip,

FIG. 4 shows the detail shown in FIG. 3 with a large amount of sample liquid received in the pipette tip,

FIG. 5 shows a method for dispensing a sample liquid, and

FIG. 6 shows a model-based observer.

### DETAILED DESCRIPTION

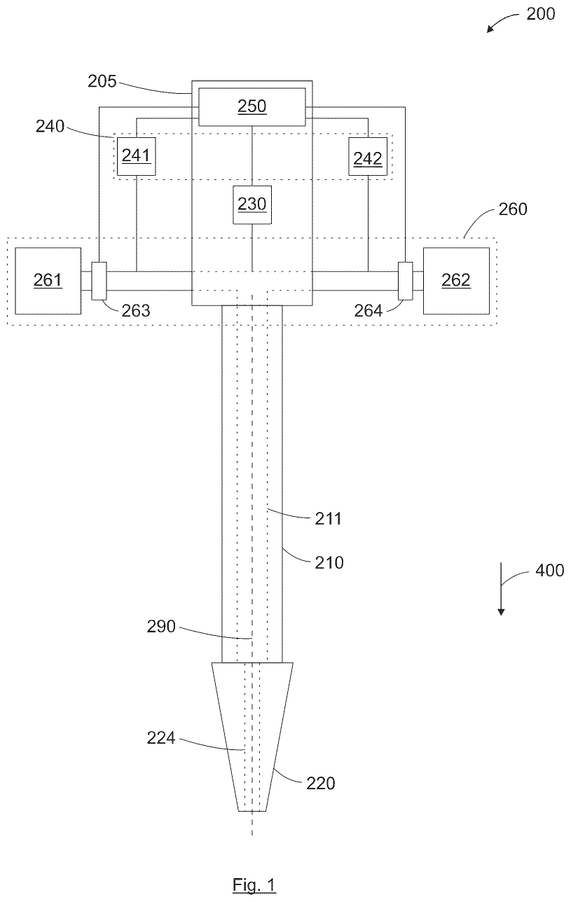

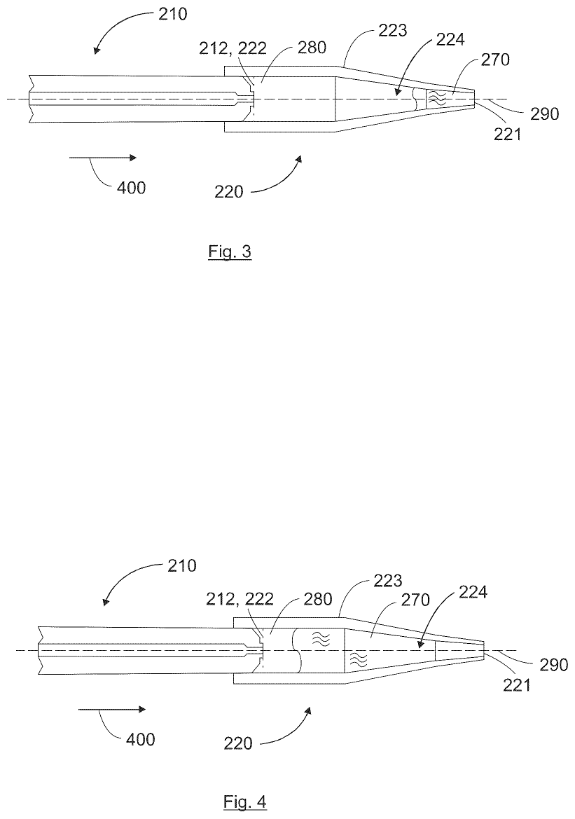

FIG. 1 shows a pipette 200 for dispensing a sample liquid 270 (see FIGS. 3 and 4). The pipette 200 has a working fluid device 260, a flow sensor arrangement 240, a pipette tip holder 210, a pipette tip 220 that can be filled with sample liquid 270, a tip pressure sensor 230 arranged on the pipette tip holder 210, and a control device 250.

The pipette tip holder 210 has a fluid channel 211, which extends along a center axis 290 with its greatest dimension. The pipette tip 220 has an inner area 224 that is fluidically connected to the fluid channel 210. Working fluid 280 is contained in the fluid channel 210 (see FIGS. 3 and 4).

Purely by way of example, the pipette 200 has a head part 205, in which, also by way of example, the control device 250 and the tip pressure sensor 230 are arranged. The tip pressure sensor 230 is electrically connected to the control device 250 and fluidically connected to the fluid channel 211. Furthermore, the head part 205 is arranged along a longitudinal direction 400 parallel to the center axis 290 in front of the pipette tip holder 210, which in turn is arranged along the longitudinal direction 400 in front of the pipette tip 220.

Purely by way of example, the working fluid device 260 has a positive pressure source 261 and a negative pressure source 262. Furthermore, by way of example, the flow sensor arrangement 240 has a positive pressure sensor 241 associated with the positive pressure source 261 and a negative pressure sensor 242 associated with the negative pressure source 262. In this embodiment, the flow sensor arrangement 240 is designed to determine a flow signal based on a pressure signal from the positive pressure sensor 241 and/or a pressure signal from the negative pressure sensor 242 and a pressure signal from the peak pressure sensor 230.

For illustrative purposes only, a first valve 263 associated with the positive pressure source 261 and a second valve 264 associated with the negative pressure source 262 are provided. The first valve 263 and the second valve 264 can be moved into an open position and into a closed position. The first valve 263 is designed to establish a fluid connection between the positive pressure source 261 and the pipette tip holder 210, in particular the fluid channel 211, when the first valve 263 is moved into the open position, and to terminate the fluid connection between the positive pressure source 261 and the pipette tip holder 210, in particular the fluid channel 211, when the first valve 263 is moved into the closed position. Similarly, the second valve 264 is designed to establish a fluid connection between the negative pressure source 262 and the pipette tip holder 210, in particular the fluid channel 211, when the second valve 264 is set to the open position, and to terminate the fluid connection between the negative pressure source 262 and the pipette tip holder 210, in particular the fluid channel 211, when the second valve 264 is moved into the closed position. Furthermore, the first valve 263 and the second valve 264 are electrically connected to the control device 250, and the control device 250 is designed to move the first valve 263 and the second valve 264 into the open position and into the closed position, respectively.

Purely by way of example, the positive pressure source 261 and the negative pressure source 262 are arranged outside the head part 205. Alternatively, the positive pressure source 261 and the negative pressure source 262 may be arranged inside the head part 205.

The pipette 200 shown in FIG. 1 is also referred to as a dual air lock pipette.

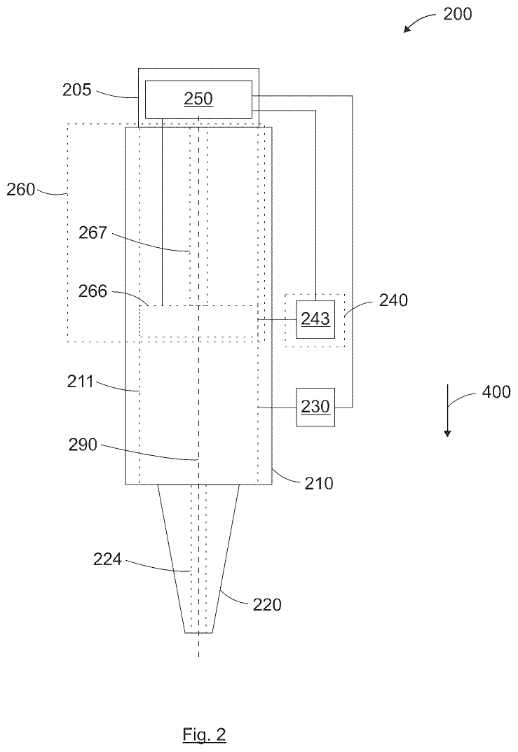

FIG. 2 shows another pipette 200 for dispensing sample liquid 280. The pipette 200 shown in FIG. 2 differs from the pipette 200 shown in FIG. 1 in terms of the flow sensor arrangement 240 and the working fluid device 260. The working fluid device 260 of the pipette 200 shown in FIG. 2 has a piston 266. For illustrative purposes only, a piston rod 267 is arranged on the piston 266. The pipette tip holder 210 of the pipette 200 shown in FIG. 2 is designed as a cylinder in which the piston 266 is guided. The piston 266 can be moved in the fluid channel 211 of the pipette tip holder 210, which is designed as a cylinder, by means of the piston rod 267.

Purely by way of example, the control device 250 is electrically connected to the piston 266 in order to control and/or regulate the movement of the piston 266 in the fluid channel 211.

In the pipette 200 shown in FIG. 2, the flow sensor arrangement 240 has a displacement sensor 243 that is associated with the piston 266. The displacement sensor 243 is designed to detect a displacement signal that depends on the position of the piston 266 in the fluid channel 211, which is designed as a cylinder.

FIGS. 3 and 4 each show a detail of a pipette 200, for example, the pipette 200 shown in FIG. 1 or the pipette 200 shown in FIG. 2. The details shown in FIGS. 3 and 4 show the pipette tip 220 and a front part of the pipette tip holder 210 in relation to the longitudinal direction 400. In the configuration shown in FIG. 3, less sample liquid 270 is received in the pipette tip 220 than in the configuration shown in FIG. 4. Accordingly, in the configuration shown in FIG. 4, there is more sample liquid 270 and thus less working fluid 280 in the pipette tip 220 than in the configuration shown in FIG. 3.

The pipette tip 220 has an outer shell 223 that surrounds the inner area 224. The pipette tip 220 also has a dispensing opening 221 that is spaced apart from the pipette tip holder 210. In addition, the pipette tip 220 has a working fluid opening 222 facing the pipette tip holder 210. Sample liquid 270 can pass through the dispensing opening 221 so that it is dispensed or aspirated into the inner area 224 of the pipette tip 220. Working fluid 280 can pass through the working fluid opening 222 to create a negative pressure in the inner area 224 so that sample liquid 270 is aspirated, or to create a positive pressure in the inner area 224 so that sample liquid 270 is dispensed.

The pipette tip holder 210 has a first fluid channel opening 212 facing the pipette tip 220 through which working fluid 280 can pass. If positive pressure is generated in the fluid channel 211 (see FIGS. 1 and 2), working fluid 280 received in the fluid channel 211 is moved out of the fluid channel 211 and enters the inner area 224 through the first fluid channel opening 212. If negative pressure is generated in the fluid channel 211 (see FIGS. 1 and 2), working fluid 280 received in the inner area 224 is moved out of the inner area 224 and enters the fluid channel 211 through the working fluid opening 222. If the pipette tip 220 is coupled to the pipette tip holder 210 as shown in FIGS. 3 and 4, the first fluid channel opening 212 of the fluid channel 211 and the working fluid opening 222 of the pipette tip 220 are arranged at least partially congruently.

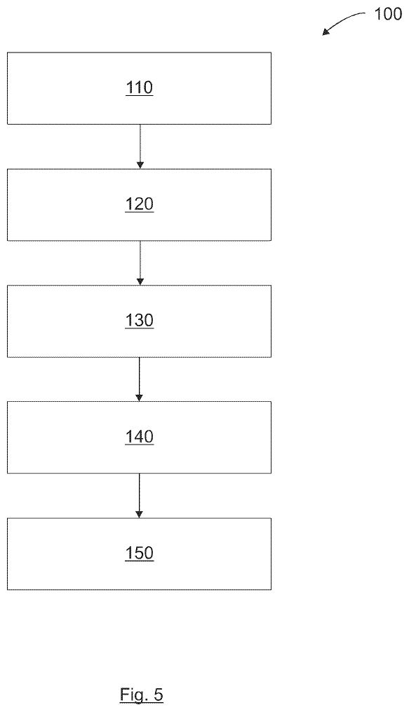

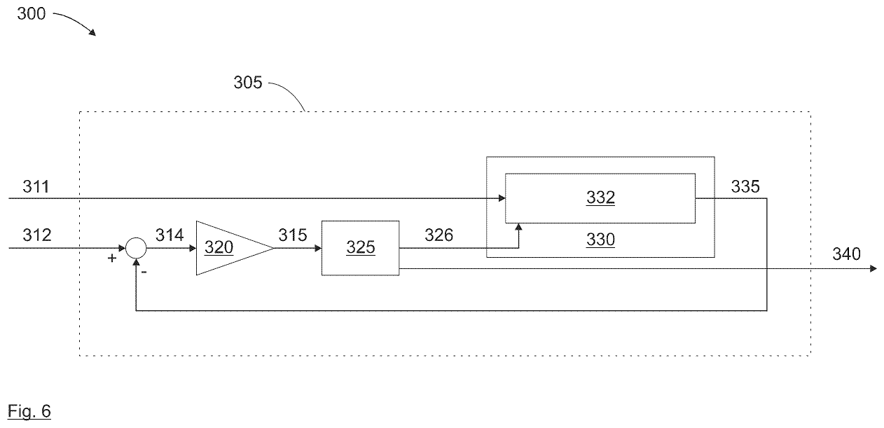

FIG. 5 shows a method 100 for dispensing a sample liquid 270. The control device 250 of the pipette(s) 200 described above is designed to carry out the method 100. The method 100 comprises at least five successive steps 110, 120, 130, 140, 150, namely a first step 110, a second step 120, a third step 130, a fourth step 140, and a fifth step 150. In the first step 110, a pressure signal from the peak pressure sensor 230 is evaluated by the control device 250 in order to obtain a working fluid pressure 311 (see FIG. 6). This is followed by the second step 120, in which a flow signal from the flow sensor arrangement 240 is evaluated by the control device 250 in order to obtain a sample liquid flow rate 312.

This is followed by the third step 130, in which a pressure for working fluid 280 received in the pipette tip holder 210 is changed by the working fluid device 260 in accordance with a first curve for the working fluid pressure 311, in particular as specified by the control device 250, so that sample liquid 270 passes through the dispensing opening 221 of the pipette tip 220, which is spaced apart from the pipette tip holder 210. This is followed by the fourth step 140, in which a flow resistance characteristic value 340 (see FIG. 6) for the sample liquid 270 is determined, taking into account the working fluid pressure 311 and the sample liquid flow rate 312. Finally, the fifth step 150 follows, in which the pressure for the working fluid 280 received in the pipette tip holder 210 is changed again with the working fluid device 260 in accordance with a second curve for the working fluid pressure 311, in particular as specified by the control device 250, whereby the second curve for the working fluid pressure 311 is determined taking into account the flow resistance characteristic value 340, so that a predetermined sample liquid quantity passes through the dosing opening 221.

FIG. 6 shows a model-based observer 300. Purely by way of example, the model-based observer 300 is applied in the fourth step 140 of the method 100 shown in FIG. 5. The model-based observer 300 can be used to determine the flow resistance characteristic value 340. The model-based observer 300 comprises a simulated control 305. Furthermore, the working fluid pressure 311 and the sample liquid flow rate 312 are used as reference variables for the simulated control 305. The working fluid pressure 311 and the sample liquid flow rate 312 are fed into a parameter model 332, which is used in a simulation 330.

The simulation 330 is used to determine a simulated sample liquid flow rate 335, which is used as a control variable. The parameter model 332 used in the simulation 330 combines several physical properties or effects relating to the sample liquid 270, in particular those from the group: kinematic viscosity of the sample liquid 270, density of the sample liquid 270, inner cross-section of the pipette tip 220, and profile of an inner cross-section of the pipette tip 220.

At the same time, the simulated sample liquid flow rate 335 is used as a measured variable and fed back to the sample liquid flow rate 312. Here, a control deviation 314 is determined as the difference between the sample liquid flow rate 312 and the simulated sample liquid flow rate 335. The control deviation 314 is fed to a controller 320 of the simulated control system 305 and amplified by the latter in accordance with a gain function. Subsequently, a controller output 315 issued by the controller 320 is fed to a disturbance model 325 of the simulated control system 305. The disturbance model 325 of the simulated control system 305 is designed as a function with which a preliminary flow resistance characteristic value 326 is determined. By way of example, the disturbance model 325 has an integrator with which the preliminary flow resistance characteristic value 326 is output as a time integral of the controller output 315. In particular, the disturbance model 325 is used to represent the kinematic viscosity of the sample liquid, the density of the sample liquid, and/or geometric properties of the pipette tip 220 as disturbance variables.

The preliminary flow resistance characteristic value 326 is used as a parameter of the simulated control 305. The working fluid pressure 311 is fed into the simulation 330 as an input variable. By way of example, the preliminary flow resistance characteristic value 326 is also output as a flow resistance characteristic value 340.

In particular, the preliminary flow resistance characteristic value 326 is used as a variable parameter of the simulated control 305. In this context, variable parameter means that the preliminary flow resistance characteristic value 326 is fed into the parameter model 332 as a parameter, whereby parameter here means that the preliminary flow resistance characteristic value 326 is constant. However, due to the feedback of the simulated sample liquid flow rate 335 with the measured sample liquid flow rate 312, which leads to the control deviation 314 fed to the controller 320, the preliminary resistance characteristic value 326 is nevertheless indirectly changed in any case. This means that, with regard to the simulated portion of the simulated control 305, the preliminary flow resistance characteristic value 326 is a parameter, and with regard to the real portion of the simulated control 305, the preliminary flow resistance characteristic value 326 is variable.

1. A method for dispensing a sample liquid, with a pipette comprising a working fluid device, a flow sensor arrangement, a pipette tip holder, a pipette tip that can be filled with sample liquid, a tip pressure sensor arranged on the pipette tip holder, and a control device, comprising the steps of:
evaluating a pressure signal from the tip pressure sensor with the control device to obtain a working fluid pressure,
evaluating a flow signal from the flow sensor arrangement with the control device to obtain a sample liquid flow rate,
changing a pressure for working fluid received in the pipette tip holder with the working fluid device according to a first curve for the working fluid pressure, so that sample liquid passes through a dispensing opening of the pipette tip spaced apart from the pipette tip holder,
determining a flow resistance characteristic value for the sample liquid, taking into account the working fluid pressure and the sample liquid flow rate, and then again changing the pressure for the working fluid received in the pipette tip holder with the working fluid device according to a second curve for the working fluid pressure, wherein the second curve for the working fluid pressure is determined taking into account the flow resistance characteristic value so that a predetermined sample liquid quantity passes through the dosing opening.

2. The method according to claim 1, wherein the again change in pressure for the working fluid received in the pipette tip holder is controlled.

3. The method according to claim 1, wherein the flow sensor arrangement is designed as a soft sensor arrangement and determines the flow signal on the basis of at least one pressure signal from a pressure sensor assigned to the working fluid device.

4. The method according to claim 3, wherein the working fluid device has a positive pressure source and/or a negative pressure source, wherein a positive pressure sensor is associated with the positive pressure source and/or a negative pressure sensor is associated with the negative pressure source, wherein the flow sensor arrangement determines the flow signal on the basis of a pressure signal from the positive pressure sensor and/or a pressure signal from the negative pressure sensor and the pressure signal from the tip pressure sensor.

5. The method according to claim 1, wherein the working fluid device has a piston and the pipette tip holder is designed as a cylinder in which the piston is guided, wherein the flow sensor arrangement is designed as a soft sensor arrangement and determines the flow signal on the basis of a displacement signal from a displacement sensor assigned to the piston and the pressure signal from the tip pressure sensor.

6. The method according to claim 1, wherein, when determining the flow resistance characteristic value, a simulated control is performed, in which the working fluid pressure is used as the input and the sample liquid flow rate is used as the reference variable, and a simulated sample liquid flow rate is determined by means of a simulation, wherein the simulated sample liquid flow rate is used as a control variable of the simulated control.

7. The method according to claim 6, wherein the sample liquid flow rate is used as a reference variable of the simulated control, wherein the simulated sample liquid flow rate is used as a measured variable of the simulated control, which is fed back to the sample liquid flow rate used as a reference variable of the simulated control.

8. The method according to claim 7, wherein a control deviation of the simulated control is determined as a difference between the sample liquid flow rate used as a reference variable of the simulated control and the simulated sample liquid flow rate used as a measured variable of the simulated control used as a measured variable of the simulated control, wherein the control deviation of the simulated control is fed to a disturbance model of the simulated control, wherein the disturbance model of the simulated control is designed as a function with which a preliminary flow resistance characteristic value is determined, wherein the preliminary flow resistance characteristic value is used as a parameter of the simulated control.

9. A pipette for dispensing a sample liquid, comprising a working fluid device, a flow sensor arrangement, a pipette tip holder, a pipette tip that can be filled with sample liquid, a tip pressure sensor arranged on the pipette tip holder, and a control device, wherein the control device is designed to execute a method according to claim 1.
